(19) United States
(12) Patent Application Publication
(10) Pub. No.: US 2026/0357616 A1
(43) Pub. Date: Nov. 12, 2026

(54) LOCKING DEVICE AND STORAGE APPARATUS

(71) Applicant: TOKAI RIKEN CO., LTD., Seki-shi (JP)

(72) Inventors: Akihiro SATO, Seki-shi (JP); Masami UMEMURA, Seki-shi (JP); Nobuhiko SEGI, Seki-shi (JP); Koicho SAKAGAMI, Seki-shi (JP)

(73) Assignee: TOKAI RIKEN CO., LTD., Seki-shi, Gifu (JP)

(21) Appl. No.: 19/477,125

(22) PCT Filed: Sep. 3, 2024
(86) PCT No.: PCT/JP2024/031548

§ 371 Date: Oct. 21, 2025

(30) Foreign Application Priority Data
Dec. 27, 2023 (JP) 2023-221742

(51) Int. Cl. E05B 47/00

(52) U.S. Cl. CPC E05B 47/0004; E05B 2047/0016; E05B 2047/0084

(57) ABSTRACT

A lever lock plate that, in a locked state, restricts a first switching operation (first restriction); a first solenoid that drives a first restriction means in order to implement or release the first restriction; a hook that is operable between a closed position at which a door is held in a closed state and an open position at which said hold is released; a locking lever that, in a locked state, restricts operation of the hook from the closed position to the open position (second restriction); a second solenoid that drives the locking lever in order to implement or release the second restriction; and a switching lever that can forcibly drive the first switching operation and the second restriction means.

### CROSS-REFERENCE TO RELATED APPLICATIONS

This is a US national phase application based on the PCT International Patent Application No. PCT/JP2024/031548 filed on Sep. 3, 2024, and claiming the priority to Japanese Patent Application No. 2023-221742 filed on Dec. 27, 2023, the entire contents of which are incorporated by reference herein.

### TECHNICAL FIELD

The invention relates to a locking device capable of performing a first switching operation of switching from a locked state in which a door of a storage unit capable of storing items is locked to an unlocked state in which the door is unlocked, and a second switching operation of switching from the unlocked state to the locked state, and a storage apparatus provided with the locking device.

### BACKGROUND ART

Conventionally, as storage apparatuses for temporarily storing and keeping users' items, locker apparatuses installed in railway stations and delivery lockers installed in apartment buildings have been widely used. Each storage apparatus includes storage units capable of storing items, doors for opening/closing the storage units, and locking devices for locking or unlocking the doors. For example, as the locking device, an electric locking device disclosed in Patent Document 1 has been known.

The electric locking device includes a locking member rotatable between a locking angle for locking the door of the storage unit and an unlocking angle for unlocking the door, a restricting means for restricting rotation of the locking member from the locking angle to the unlocking angle, and a solenoid for operating the restricting means. When the door is locked, the solenoid is not energized and the restricting means restricts the rotation of the locking member. Conversely, when the solenoid is energized, releasing the restriction, the locking member is allowed to rotate from the locking angle to the unlocking angle. Thus, the door is unlocked.

### RELATED ART DOCUMENTS

### Patent Documents

Patent Document 1: Japanese unexamined patent application publication No. 2007-107292

### SUMMARY OF INVENTION

### Problems to be Solved by the Invention

The locking device conventionally known involves the following problems. When too many items are put in the storage unit, the door is pushed in an opening direction. Accordingly, a hook of the door applies a load to the restricting means and the solenoid via the locking member, which may block or disturb the operation of the restricting means, and hence the operation of the solenoid. If the operation of the solenoid is blocked, the restriction of the locking member by the restricting means could not be released. This may disable the door of the storage apparatus to be opened by a user.

The present disclosure has been made to address the above problems and has a purpose to provide a locking device and a storage apparatus, configured to be easily unlocked even if too many items are put into a storage unit.

### Means of Solving the Problems

To achieve the above-mentioned purpose, a locking device in one aspect of the present disclosure is configured as below.
(1) In a locking device capable of performing: a first switching operation of switching from a locked state in which a door of a storage unit capable of storing an item is locked to an unlocked state in which the door is unlocked; and a second switching operation of switching from the unlocked state to the locked state, the locking device includes: first restricting means that implements restriction (first restriction) of the first switching operation, in the locked state; first drive means that drives the first restricting means to implement or release the first restriction; a locking member movable between a closed position for holding of the door in a closed state and an open position for releasing the holding; second restricting means that implements restriction (second restriction) of movement of the locking member from the closed position to the open position, in the locked state; second drive means that drives the second restricting means to implement or release the second restriction; and a manual lever capable of forcibly implementing the first switching operation and driving the second restricting means.
(2) In the locking device described in (1), preferably, including: detection means that detects that the second restriction is released; and a controller that controls the locking device, the controller contains a control program configured to: activate the first drive means to release the first restriction; then, activate the second drive means to issue a command to release the second restriction; and provide a notification prompting to forcibly perform the first switching operation using the manual lever when the detection means does not detect that the second restriction is released even after a predetermined time elapses after the first restriction is released.

To solve the aforementioned problems, a storage apparatus in one aspect of the invention is provided with the locking device described in (1) or (2).

### Effects of the Invention

The locking device and the storage apparatus of the invention can be easily unlocked, even if too many items are put in a storage unit.

### BRIEF DESCRIPTION OF THE DRAWINGS

FIG. 1 is a front view of a locker apparatus.

FIG. 2 is an electric structure of the locker apparatus.

FIG. 3 is a partial enlarged view of a part A in FIG. 1.

FIG. 4 is a cross-sectional view taken along a line B-B in FIG. 3, showing a state in which a door is in a locked state.

FIG. 5 is a cross-sectional view of a locking device, similar to FIG. 4, showing a state in which a switching lever is released from restriction.

FIG. 6 is a cross-sectional view of the locking device, similar to FIG. 4, showing a state in which the switching lever is in an unlocking position and the door is in an unlocked state.

FIG. 7 is a cross-sectional view of the locking device, similar to FIG. 4, showing a state in which the door is opened.

FIG. 8A is a flowchart of a storage program.

FIG. 8B is a flowchart of the storage program.

FIG. 9A is a flowchart of the storage program.

FIG. 9B is a flowchart of the storage program.

FIG. 10 is a cross-sectional view of the locking device, similar to FIG. 4, showing a state in which emergency unlocking is performed.

FIG. 11A is a cross-sectional view taken along a line C-C in FIG. 10, showing a normal usage state of the locking device.

FIG. 11B is a cross-sectional view taken along the line C-C in FIG. 10, showing a state in which the locking device is subjected to emergency unlocking.

FIG. 11C is a cross-sectional view taken along the line C-C in FIG. 10, showing a state in which the locking device can be removed from a trim.

FIG. 12 is a front view of the locking device corresponding to a right-hand door.

FIG. 13A is a left side view of a hook.

FIG. 13B is a front view of the hook.

FIG. 13C is a right side view of the hook.

### MODE FOR CARRYING OUT THE INVENTION

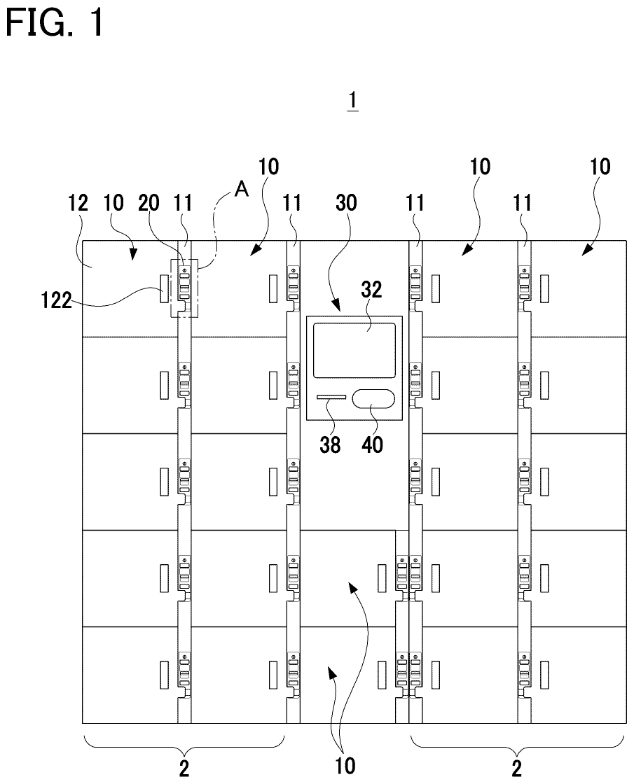

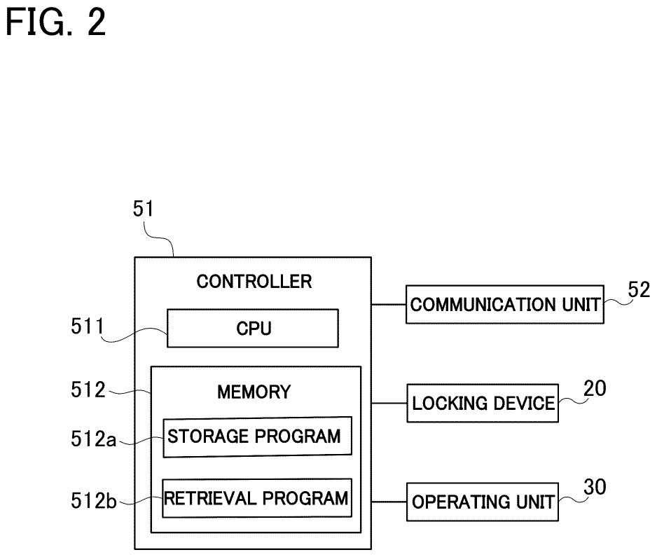

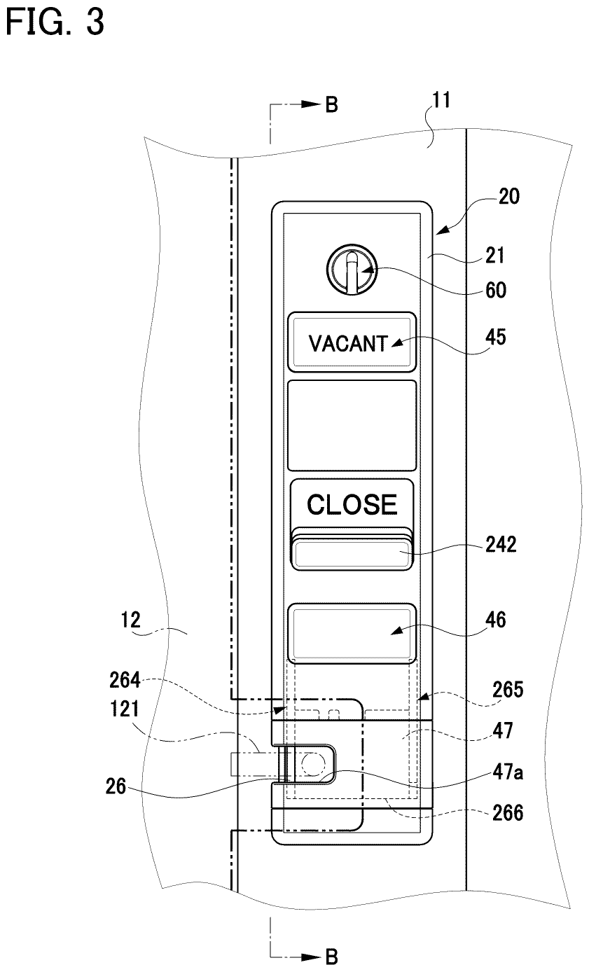

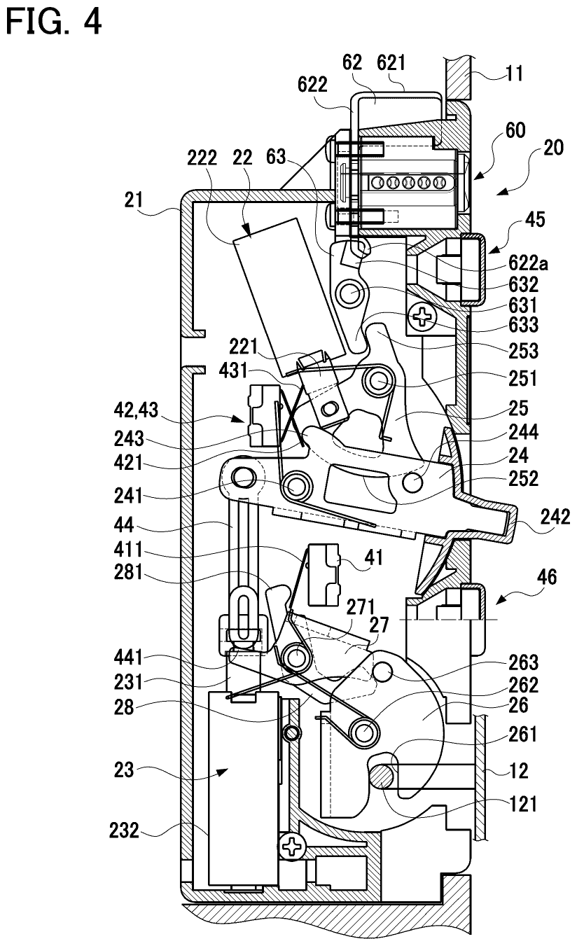

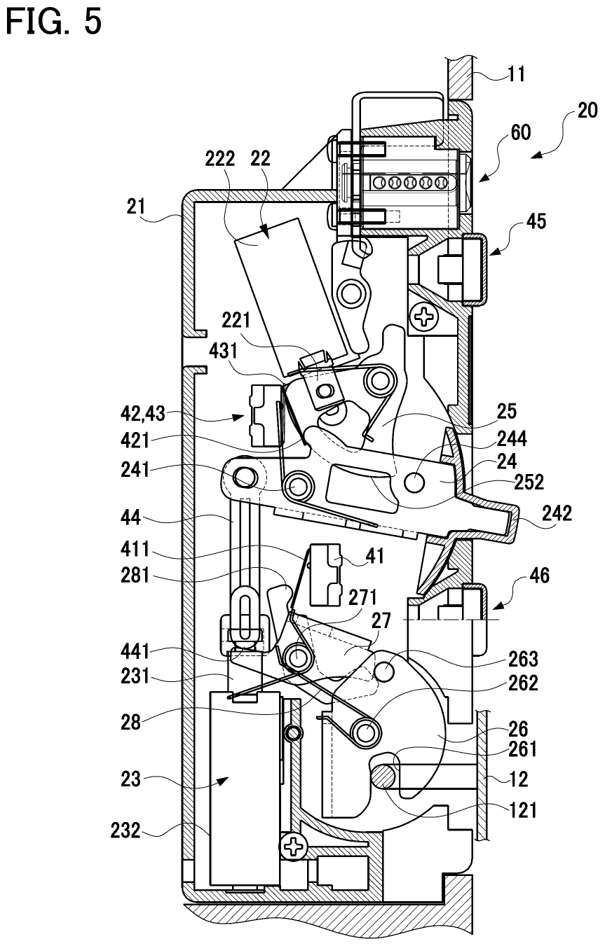

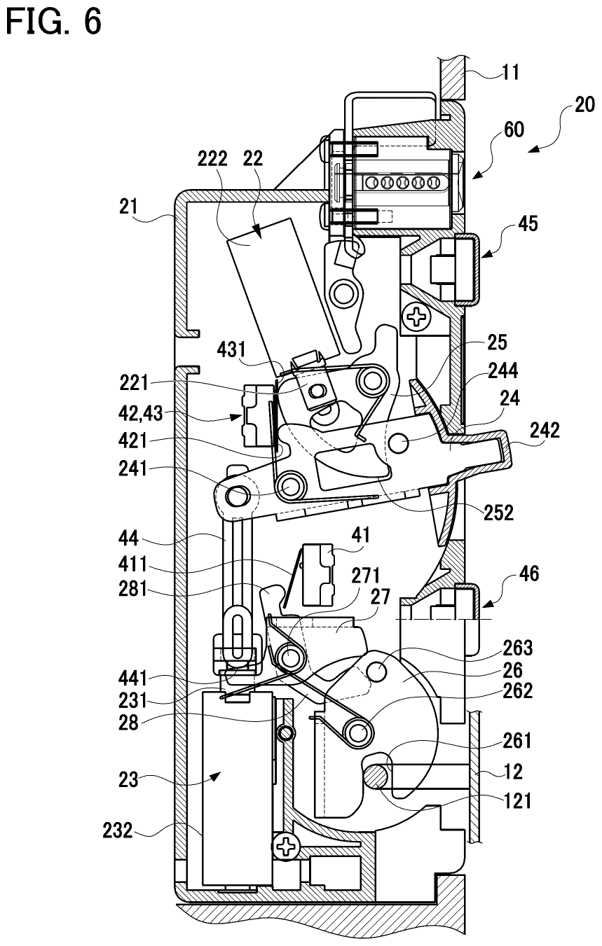

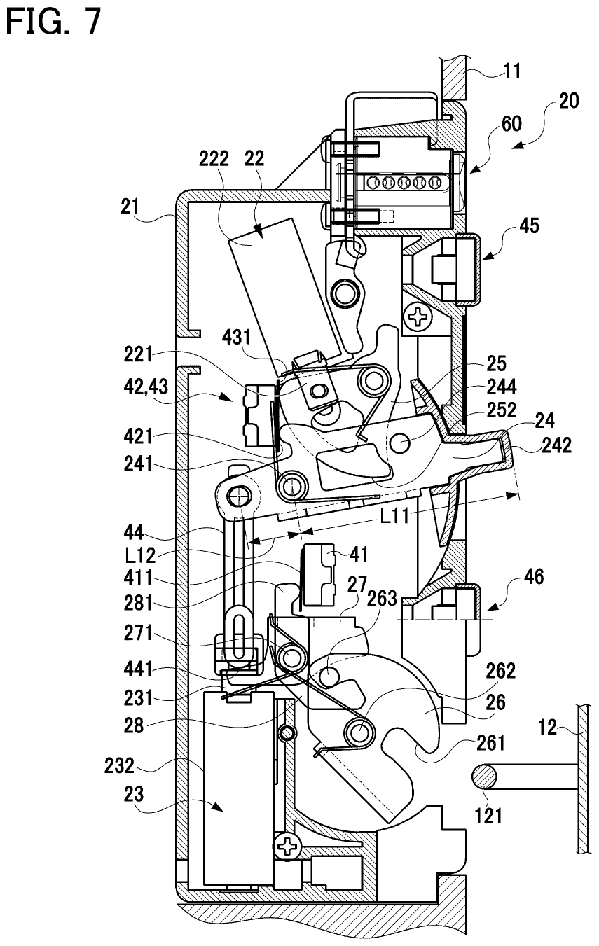

A detailed description of a locker apparatus 1 (one example of a storage apparatus) in an embodiment of a storage apparatus of the present invention will now be given referring to the accompanying drawings. FIG. 1 is a front view of the locker apparatus 1. FIG. 2 is an electric structure of the locker apparatus 1. FIG. 3 is a partial enlarged view of a part A in FIG. 1. FIG. 4 is a cross-sectional view taken along a line B-B in FIG. 3, showing a state in which a door 12 is in a locked state. FIG. 5 is a cross-sectional view of a locking device 20, similar to FIG. 4, showing a state in which a switching lever 24 is released from restriction. FIG. 6 is a cross-sectional view of the locking device 20, similar to FIG. 4, showing a state in which the switching lever 24 is in an unlocking position and the door 12 is in an unlocked state. FIG. 7 is a cross-sectional view of the locking device 20, similar to FIG. 4, showing a state in which the door 12 is opened.

### Configuration of Locker Apparatus

The locker apparatus 1 according to the present embodiment is installed, for example, in a railway station and used to temporarily store and keep one or more pieces of baggage, or personal items. The locker apparatus 1 has a plurality of storage units 10 capable of storing baggage of users. Specifically, two structures (locker structures 2) each including a total of ten storage units 10 arranged in five rows and two columns are placed with an operating unit 30 interposed therebetween. The number of storage units 10 is merely an example and may be increased or decreased as needed. In the present embodiment, all the storage units 10 have the same opening width, but this is also merely an example. As an alternative, storage units may have different opening widths.

The storage units 10 each have, on the front, a door 12 that can be opened and closed independently for each storage unit 10. The doors 12 of the storage units 10 located on the left side of the operating unit 30 are left-hand doors, which are opened to the left in the figure when respective handles 122 are pulled. The doors 12 of the storage units 10 located on the right side of the operating unit 30 are right-hand doors, which are opened to the right in the figure when respective handles 122 are pulled. For the left-hand doors 12, the locking devices 20 are provided on casing frames 11 on the right side of the relevant doors 12 to lock or unlock the doors 12. On the other hand, for the right-hand doors 12, the locking devices 20 are provided on casing frames 11 on the left side of the relevant doors 12. The configuration of the locking devices 20 will be described later.

In the locker apparatus 1, the operating unit 30 is provided between the right and left locker structures 2, 2 to allow users to place their baggage into the storage units 10 and pick up the baggage therefrom, and pay a fee, by operating the operating unit 30. In the present embodiment, the storage units 10 are also provided below the operating unit 30, they may be used as the space for storing maintenance tools for administrators.

The operating unit 30 includes, for example, a display unit 32, such as a touch panel, a printer 38 for printing receipts for verification of use, an IC card reader 40 for reading IC tags embedded in IC cards, and others. Here, the IC cards refer to cards that can be used for settlement with electronic money, such as transportation IC cards.

### Locking Device

The locking devices 20 each include a rectangular parallelepiped case 21, as shown in FIGS. 3 to 7. Each case 21 internally includes, mainly, a first solenoid 22 (one example of first drive means), a second solenoid 23 (one example of second drive means), a switching lever 24 (one example of a manual lever), a lever lock plate 25 (one example of first restricting means), a hook 26 (one example of a locking member), a locking lever 27 (one example of second restricting means), an open/close switch lever 28, a first switch 41, a second switch 42 (one example of detecting means), and a third switch 43. In FIGS. 4 to 7, the second switch 42 and the third switch 43 are positioned overlapping each other in the depth direction of the figures.

Furthermore, the locking device 20 includes a green LED 45 that emits green light and an orange LED 46 that emits orange light in order to indicate the usage status of the storage unit 10. Their externally visible parts in FIG. 3 are lens members covering light-emitting elements, and the light-emitting elements are built in the corresponding lens members.

The first solenoid 22 is configured such that a plunger 221 protrudes from a frame 222 when power supply is turned off, and the plunger 221 retracts into the frame 222 when power supply is turned on. The lever lock plate 25 is connected to the tip of the plunger 221. As the plunger 221 protrudes and retracts, the lever lock plate 25 is rotated about a rotary shaft 251.

The lever lock plate 25 is provided with a restricting part 252 for restricting, or preventing, the movement of the switching lever 24, and is turned between a restriction position at which the restricting part 252 restricts the movement of the switching lever 24 and a release position at which the restriction by the restricting part 252 is released. FIG. 4 shows the lever lock plate 25 located in the restriction position and FIGS. 5 to 7 show the lever lock plate 25 located in the release position.

Near the lever lock plate 25, the third switch 43 is provided. When the lever lock plate 25 is rotated from the restriction position to the release position, the restricting part 252 presses a lever 431 of the third switch 43, turning on the third switch 43. On the other hand, when the lever lock plate 25 is rotated from the release position to the restriction position, the restricting part 252 moves away from the third switch 43, turning off the third switch 43. Based on the ON/OFF operation of the third switch 43, it is possible to detect whether the lever lock plate 25 is located in the release position or the restriction position.

The switching lever 24 is a lever for switching the door 12 between the locked state and the unlocked state, and is rotatable about a rotary shaft 241 between a locking position for placing the door 12 in the locked state and an unlocking position for placing the door 12 in the unlocked state. The switching lever 24 shown in FIGS. 4 and 5 is located in the locking position, and the switching lever 24 shown in FIGS. 6 and 7 is located in the unlocking position.

The switching lever 24 is provided with a lock pin 244. For example, as shown in FIG. 4, while the switching lever 24 is located in the locking position and the lever lock plate 25 is located in the restriction position, even if a user attempts to turn the switching lever 24 to the unlocking position, the restricting part 252 of the lever lock plate 25 is located in the path of movement of the switching lever 24, preventing the switching lever 24 from rotating to the unlocking position. In contrast, as shown in FIG. 5, when the lever lock plate 25 is placed in the release position, the restricting part 252 is retracted out of the movement path of the lock pin 244, allowing the switching lever 24 to rotate to the unlocking position.

The switching lever 24 is further provided with a protruding portion 243 for turning ON the second switch 42. When the switching lever 24 rotates from the locking position to the unlocking position, the protruding portion 243 comes close to the second switch 42, pressing a lever 421 of the second switch 42, turning on the second switch 42. In contrast, when the switching lever 24 rotates from the unlocking position to the locking position, the protruding portion 243 moves away from the second switch 42, turning off the second switch 42. Based on the ON/OFF operation of the second switch 42, it is possible to detect whether the switching lever 24 is located in the locking position or the unlocking position.

The switching lever 24 has a knob 242 at one of longitudinal ends, which protrudes from the case 21 and is used for manual operation of the switching lever 24. The locking device 20 in the present embodiment is configured such that, when the switching lever 24 is located in the unlocking position, a user is allowed to pinch and flip up the knob 242 to the locking position. The other end opposite the knob 242 relative to the rotary shaft 241 is connected to a plunger 231 of the second solenoid 23 located below via a coupling bar 44.

The second solenoid 23 is configured such that the plunger 231 protrudes from a frame 232 when power supply is turned off, and the plunger 231 retracts into the frame 232 when power supply is turned on. Since the switching lever 24 is connected to the plunger 231 through the coupling bar 44, the switching lever 24 is rotated about the rotary shaft 241 between the locking position and the unlocking position in association with retraction and protrusion of the plunger 231.

The hook 26 is provided with an engagement part 261 that engages with a door-side hook 121 of the door 12. The hook 26 is further provided with a rotary shaft 262 above the engagement part 261. The hook 26 rotates between a closed position at which the engagement part 261 engages with the door-side hook 121 and an open position at which the engagement part 261 disengages the door-side hook 121. The hook 26 shown in FIG. 4 to FIG. 6 is in the closed position and the hook 26 shown in FIG. 7 is in the open position. When the hook 26 is in the closed position and the door 12 is opened, the door-side hook 121 is moved rightward in the figure. This moving door-side hook 121 causes the hook 26 to rotate counterclockwise in the figure to the open position. When the hook 26 is in the open position and the door 12 is further opened, the door-side hook 121 is disengaged from the engagement part 261. On the other hand, while the hook 26 is in the open position, when the door 12 is closed, the door-side hook 121 enters the engagement part 261 of the hook 26 again. As the door 12 is further closed, the door-side hook 121 moving leftward in the figure causes the hook 26 to rotate clockwise in the figure to the closed position.

The hook 26 is not allowed to rotate from the closed position to the open position while the switching lever 24 is located in the locking position, and the hook 26 is allowed to rotate while the switching lever 24 is located in the unlocking position. The details thereof are as below.

The hook 26 has a lock pin 263. While the switching lever 24 is located in the locking position, the locking lever 27 is located in the path of movement of the lock pin 263 of the hook 26 that attempts to rotate, as shown in FIG. 4 and FIG. 5. Therefore, the hook 26 is not allowed to rotate to the open position (i.e., the door 12 comes into the locked state and cannot be opened). In contrast, when the switching lever 24 is placed in the unlocking position, as shown in FIG. 6, the pressing part 441 of the coupling bar 44 causes the locking lever 27 to rotate about the rotary shaft 271 and move out of the movement path of the lock pin 263. Thus, the hook 26 is allowed to rotate to the open position (i.e., the door 12 comes into the unlocked state and can be opened). Releasing the restriction by the locking lever 27 is performed at the same time when the switching lever 24 is placed in the unlocking position. Thus, detecting by the second switch 42 that the switching lever 24 is placed in the unlocking position is equivalent to detecting that the restriction by the locking lever 27 is released.

Subsequently, after the door 12 is closed, rotating the hook 26 to the closed position, when the switching lever 24 is placed in the locking position, causing the locking lever 27 to return to its original position by a spring, so that the hook 26 is not allowed to rotate (i.e., the door 12 is in the locked state and cannot be opened) again. In other words, when the switching lever 24 is located in the unlocking position, the door 12 is in the unlocked state, and when the switching lever 24 is located in the locking position, the door 12 is in the locked state. Rotating the switching lever 24 from the locking position to the unlocking position means switching of the door 12 from the locked state to the unlocked state (a first switching operation), and rotating the switching lever 24 from the unlocking position to the locking position means switching of the door 12 from the unlocked state to the locked state (a second switching operation).

When the hook 26 is placed in the open position, the lock pin 263 causes the open/close switch lever 28 to rotate about the rotary shaft 271. When the open/close switch lever 28 rotates, an end part (a protruding portion 281) of the open/close switch lever 28, opposite a part contacting with the lock pin 263 relative to the rotary shaft 271, comes close to the first switch 41 and presses a lever 411 of the first switch 41, so that the first switch 41 is turned ON. In contrast, when the hook 26 is placed in the closed position, the open/close switch lever 28 returns to its original position by a spring. That is, the protruding portion 281 moves away from the first switch 41, so that the first switch 41 is turned OFF. Based on the ON/OFF operation of the first switch 41, it is possible to detect whether the hook 26 is located in the open position or the closed position (i.e., whether the door 12 is located in an open state or a closed state).

### Controller

Furthermore, the locker apparatus 1 is provided with the controller 51 that controls the locking devices 20 in response to the operation received on the operating unit 30. The controller 51 includes a CPU 511 and a memory 512 as shown in FIG. 2. The memory 512 stores, for example, a storage program 512a for executing a control when placing baggage into a storage unit 10 and a retrieval program 512b for executing a control when retrieving the baggage from the storage unit 10. The controller 51 is electrically connected to the locking devices 20 and the operating unit 30, and controls the locking devices 20 and displays images on the display unit 32 of the operating unit 30, and other operations, in accordance with the behavior of the storage program 512a or the retrieval program 512b. The controller 51 is connected to a communication unit 52, and thus the locker apparatus 1 can communicate with a management device (not shown) via the communication unit 52. The management device is a higher-level device for the locker apparatus 1, installed in a station yard or at any other location.

### Operation of storing Baggage

The locker apparatus 1 configured as above operates as follows for users to store baggage.

Among a plurality of storage units 10, a storage unit or storage units 10 in which no items are stored (in which a user is allowed to place baggage) are in the standby mode. At that time, the storage unit or storage units 10 in the standby mode are in the locked state. In other words, the corresponding locking device or locking devices 20 are in the state shown in FIG. 4. In this state, the green LED 45 of each locking device 20 is lit and the orange LED 46 is off. The lit green LED 45 indicates to a user that the relevant storage unit 10 is available.

To store the baggage, the user first performs an acceptance operation for start of use on the operating unit 30. Specifically, for example, a virtual button labeled “Start Use” is displayed on the display unit 32, and the acceptance operation is started when the user touches this virtual button.

Then, the display unit 32 displays a usage fee, and the user who agrees to the fee by tapping a transportation IC card on the IC card reader 40 to pay the fee. During this payment process, the IC card reader 40 reads the unique number of the IC tag of the IC card and stores this number in the memory 512, so that the stored number is used for authentication when the baggage is to be retrieved. Upon completion of the payment, the printer 38 prints a receipt as verification of use. The payment method is not limited to a method using an IC card, and may be another method using a credit card or a QR code, or more than one method may be selectively combined. For payment using the QR code, it is necessary to provide a reader for reading a QR code (registered trademark) in the operating unit 30. For payment using a method other than an IC card, it is conceivable to print a code, such as a QR code (registered trademark), on a receipt, and authenticate the user by scanning the printed code. In the locker apparatus 1 in the present embodiment, all the storage units 10 have the same opening width. However, the locker apparatus 1 may be configured such that storage units have different opening widths, and users choose desired opening widths according to their items, and then make payment.

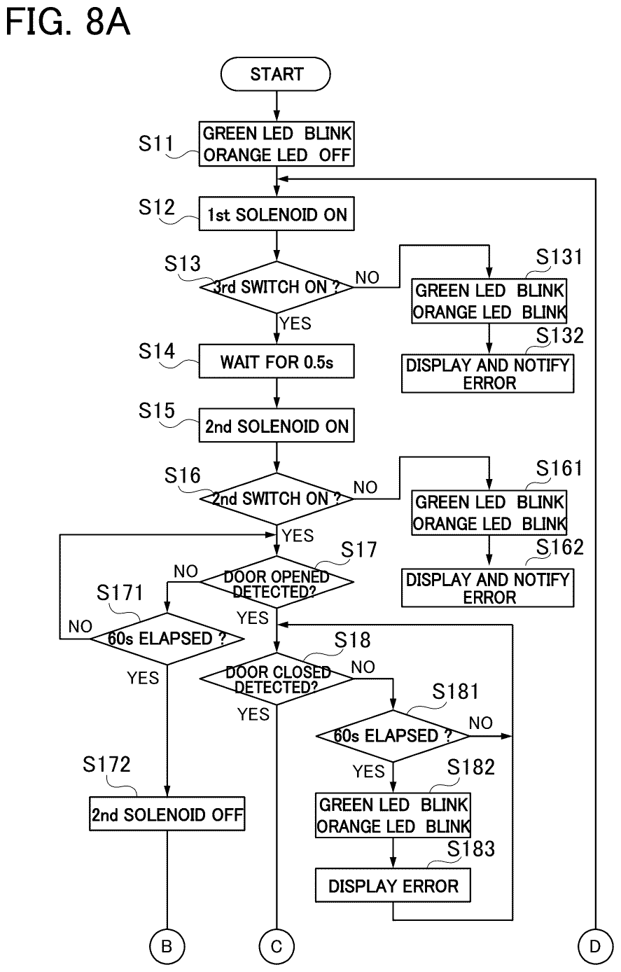

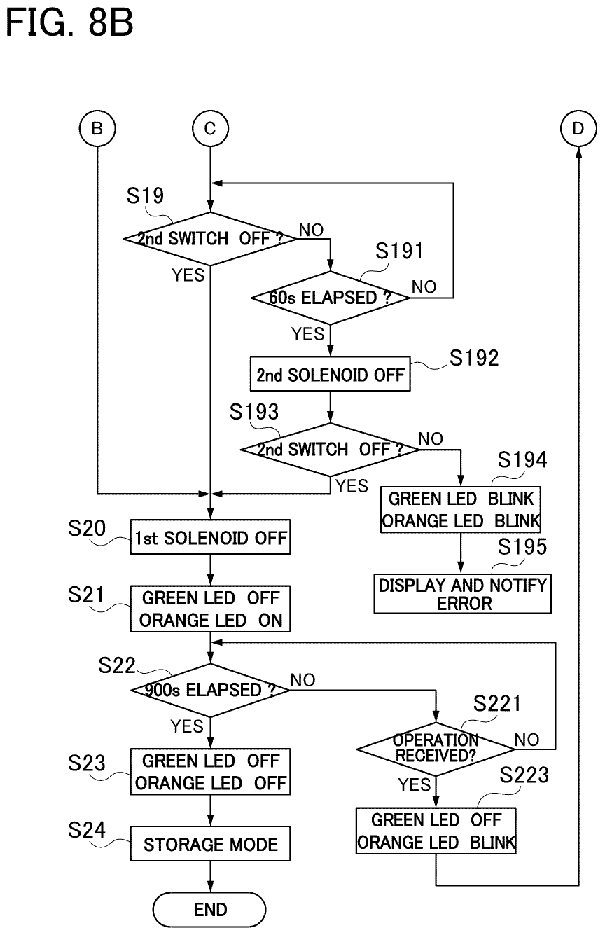

After the receipt is printed by the printer 38, the storage program 512a runs as below. FIG. 8A and FIG. 8B are flowcharts of the storage program 512a.

Firstly, among the storage units 10, the green LED 45 of the locking device 20 corresponding to the storage unit 10 available to a user for storing his/her baggage is blinked (step S11 in FIG. 8A). This indicates to the user the position of the storage unit 10 available for storage of the baggage. The orange LED 46 remains turned off.

Secondly, the first solenoid 22 is energized (step S12 in FIG. 8A), rotating the lever lock plate 25 from the restriction position (the position shown in FIG. 4) to the release position (the position shown in FIG. 5). Whether or not the lever lock plate 25 is placed in the release position is detected by the third switch 43 (step S13 in FIG. 8A).

When the third switch 43 does not detect that the lever lock plate 25 is located in the release position (step S13: NO in FIG. 8A), indicating that the locking device 20 may have a malfunction, the green LED 45 and the orange LED 46 are blinked (step S131 in FIG. 8A), and an error is displayed on the display unit 32 of the operating unit 30 and the error is notified to a management device via the communication unit 52 (step S132 in FIG. 8A). The error can be cleared by the management device.

When the third switch 43 detects that the lever lock plate 25 is located in the release position (step S13: YES in FIG. 8A), the program waits for a standby time of 0.5 second after detection (step S14 in FIG. 8A), and then the second solenoid 23 is energized (step S15 in FIG. 8A), rotating the switching lever 24 from the locking position (the position shown in FIG. 5) to the unlocking position (the position shown in FIG. 6). The above-mentioned standby time of 0.5 second is merely an example.

Whether or not the switching lever 24 is placed in the unlocking position (whether or not the first switching operation is performed) is detected by the second switch 42 (step S16 in FIG. 8A). When the second switch 42 does not detect that the switching lever 24 is located in the unlocking position (step S16: NO in FIG. 8A), indicating that the locking device 20 may have a malfunction, the green LED 45 and the orange LED 46 are blinked (step S161 in FIG. 8A), and an error is displayed on the display unit 32 of the operating unit 30 and the error is notified to the management device via the communication unit 52 (step S162 in FIG. 8A). The error can be cleared by the management device.

After the second switch 42 detects that the switching lever 24 is located in the unlocking position (step S16: YES in FIG. 8A), the first switch 41 detects whether or not the door 12 is opened by the user (i.e., whether or not the hook 26 is rotated from the closed position (the position shown in FIG. 6) to the open position (the position shown in FIG. 7) (step S17 in FIG. 8A).

When the first switch 41 does not detect that the door 12 is opened (step S17: NO in FIG. 8A), the program waits until 60 seconds elapse from detection by the second switch 42 (step S16 in FIG. 8A) (step S171: NO in FIG. 8A). After a lapse of 60 seconds (step S171: YES in FIG. 8A), power supply to the second solenoid 23 is stopped (step S172 in FIG. 8A), placing the switching lever 24 to the locking position, and then power supply to the first solenoid 22 is stopped (step S20 in FIG. 8B), placing the lever lock plate 25 to the restriction position.

In contrast, when the first switch 41 detects that the door 12 is opened (step S17: YES in FIG. 8A), it is then determined by the first switch 41 whether or not the door 12 is closed by the user (i.e., whether the hook 26 is turned from the open position (the position shown in FIG. 7) to the closed position (the position shown in FIG. 6) (step S18 in FIG. 8A).

When the first switch 41 does not detect that the door 12 is closed (step S18: NO in FIG. 8A), the program waits until 60 seconds elapse from the detection by the first switch 41 (step S17 in FIG. 8A) as the time required for the user to put the baggage into the storage unit 10 (step S181: NO in FIG. 8A).

If the door 12 is not closed even after a lapse of 60 seconds (step S181: YES in FIG. 8A), the green LED 45 and the orange LED 46 are blinked (step S182 in FIG. 8A) and the display unit 32 of the operating unit 30 displays an error to prompt the user to close the door 12 (step S183 in FIG. 8A). In the present embodiment, after displaying the error on the display unit 32 of the operating unit 30, the flow returns to step S18 and further waits for. It is however possible to take measures to make the storage unit 10 unavailable.

When the first switch 41 detects that the door 12 is closed (step 18: YES in FIG. 8A), it is then detected by the second switch 42 whether or not the switching lever 24 is placed in the locking position (i.e., whether or not the second switching operation is manually performed by the user) (step S19 in FIG. 8B).

For example, if the user forgets to rotate the switching lever 24 to the locking position and the second switch 42 does not detect that the switching lever 24 is located in the locking position (step S19: NO in FIG. 8B), the program waits until 60 seconds elapse from the detection by the first switch 41 (step S18 in FIG. 8B) (step S191: NO in FIG. 8B). After a lapse of 60 seconds (step S191: YES in FIG. 8B), power supply to the second solenoid 23 is stopped (step S192 in FIG. 8B), forcibly turning the switching lever 24 from the unlocking position (the position shown in FIG. 6) to the locking position (the position shown in FIG. 5). Setting the standby time of 60 seconds (step S191 in FIG. 8B) can provide a grace period for a user to take in and out baggage, and forcibly turning the switching lever 24 to the locking position (forcibly performing the second switching operation) can prevent the switching lever 24 from being left unlocked by a user.

Whether or not the switching lever 24 forcibly operated is placed in the locking position is detected by the second switch 42 (step S193 in FIG. 8B).

When the second switch 42 does not detect that the switching lever 24 is placed in the unlocking position (step S193: NO in FIG. 8B), indicating that the locking device 20 has any malfunction, the green LED 45 and the orange LED 46 are blinked (step S194 in FIG. 8B), and an error is displayed on the display unit 32 of the operating unit 30 and the error is notified to the management device via the communication unit 52 (step S195 in FIG. 8B). The error can be cleared by the management device.

After the second switch 42 detects that the switching lever 24 is located in the unlocking position (step S19: YES in FIG. 8B), power supply to the first solenoid 22 is stopped (step S20), moving the lever lock plate 25 from the release position (the position shown in FIG. 5) to the restriction position (the position shown in FIG. 4).

When the user rotates the switching lever 24 to the locking position and the second switch 42 detects that the switching lever 24 is located in the locking position (step S19: YES in FIG. 8B), power supply to the first solenoid 22 is also stopped (step S20 in FIG. 8B), moving the lever lock plate 25 to the restriction position.

Subsequently, the green LED 45 is turned off and the orange LED 46 is turned on (step S21 in FIG. 8B), and the program waits for 900 seconds (step S22 in FIG. 8B). This period of 900 seconds is a standby time for receiving a re-unlocking operation of switching the door 12 from the locked state to the unlocked state again, for example, if a user has forgotten to put baggage into the storage unit 10. The lit orange LED 46 provides notification to the user that the re-unlocking operation is available. This re-unlocking operation can be received on the operating unit 30.

During the standby time of 900 seconds (step S22: NO in FIG. 8B), when the operating unit 30 receives the re-unlocking operation (step S221: YES in FIG. 8B), the orange LED 46 is blinked (step S223 in FIG. 8B) to notify the user of the storage unit 10 to be re-unlocked. Thereafter, the flow returns to step S12 in which the first solenoid 22 is energized, and the same processing (step S12 to S21) is performed as in the flow for storing baggage. To prevent unauthorized third parties from re-unlocking the door 12 without permission, it is desirable to authenticate the user when the operation is accepted on the operating unit 30. Specifically, for example, the IC card that was used for payment could be used for authentication of the user.

When the re-unlocking operation is not performed (step S221: NO in FIG. 8B) and 900 seconds elapse (step S22: YES in FIG. 8B), the orange LED 46 is turned off (step S23 in FIG. 8B). Then, the storage unit 10 is switched to the storage mode in which the storage unit 10 is on standby with the baggage stored therein (step S24 in FIG. 8B), and the storage program terminates. The locking device 20 of the storage unit 10 in the storage mode has the green LED 45 and the orange LED 46 both turned off, indicating that the relevant storage unit 10 is not available to other users.

### Operation of Retrieving Baggage

Next, the operation of retrieving the baggage will be described below. To retrieve baggage from a storage unit 10, a user first performs an acceptance operation for retrieval on the operating unit 30. Specifically, for example, the display unit 32 displays a virtual button labeled “Retrieve”, and the acceptance operation is started when the user touches this virtual button.

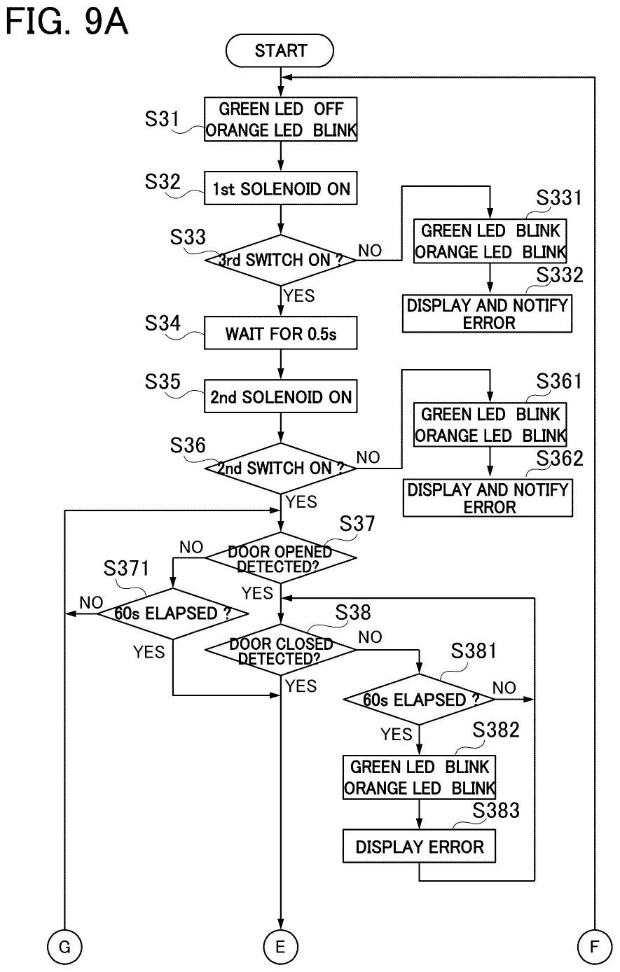

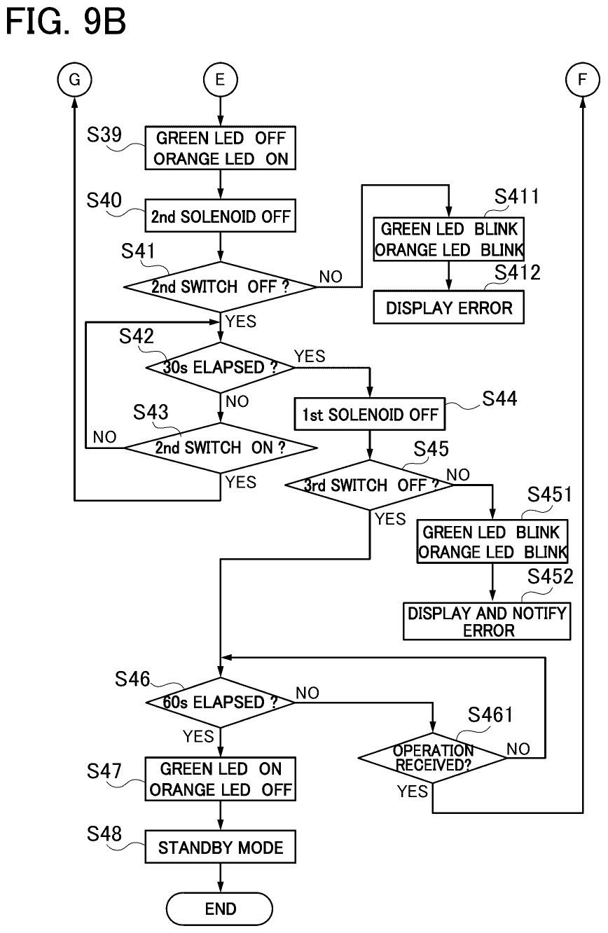

Then, authentication is performed using the IC card that was used for payment. When the authentication is successfully completed, the retrieval program 512b starts to run as below. FIG. 9A and FIG. 9B are flowcharts of the retrieval program 512b.

Firstly, among the plurality of storage units 10, the orange LED 46 of the locking device 20 corresponding to the storage unit 10 that holds the baggage of the user is blinked (step S31 in FIG. 9A). This indicates the position of the storage unit 10 holding the baggage of the user. The green LED 45 remains turned off.

Secondly, the first solenoid 22 is energized (step S32 in FIG. 9A), rotating the lever lock plate 25 from the restriction position to the release position. Whether or not the lever lock plate 25 is placed in the release position is detected by the third switch 43 (step S33 in FIG. 9A).

When the third switch 43 does not detect that the lever lock plate 25 is placed in the release position (step S33: NO in FIG. 9A), indicating that the locking device 20 may have a malfunction, the green LED 45 and the orange LED 46 are blinked (step S331 in FIG. 9A), and an error is displayed on the display unit 32 of the operating unit 30 and the error is notified to a management device via the communication unit 52 (step S332 in FIG. 9A). The error can be cleared by the management device.

When the third switch 43 detects that the lever lock plate 25 is located in the release position (step S33: YES in FIG. 9A), the program waits for a standby time of 0.5 second after detection (step S34 in FIG. 9A), and then the second solenoid 23 is energized (step S35 in FIG. 9A), rotating the switching lever 24 from the locking position to the unlocking position. The above-mentioned standby time of 0.5 second is merely an example.

Whether or not the switching lever 24 is placed in the unlocking position is detected by the second switch 42 (step S36 in FIG. 9A). When the second switch 42 does not detect that the switching lever 24 is located in the unlocking position (step S36: NO in FIG. 9A), indicating that the locking device 20 may have a malfunction, the green LED 45 and the orange LED 46 are blinked (step S361 in FIG. 9A), an error is displayed on the display unit 32 of the operating unit 30 and the error is notified to the management device via the communication unit 52 (step S362 in FIG. 9A). The error is cleared by the management device.

After the second switch 42 detects that the switching lever 24 is located in the unlocking position (step S36: YES in FIG. 9A), the first switch 41 detects whether or not the door 12 is opened by the user (i.e., whether or not the hook 26 is rotated from the closed position to the open position) (step S37 in FIG. 9A).

When the first switch 41 does not detect that the door 12 is opened (step S37: NO in FIG. 9A), the program waits until 60 seconds elapse from detection by the second switch 42 (step S36 in FIG. 9A) (step S371: NO in FIG. 9A). After a lapse of 60 seconds (step S371: YES in FIG. 9A), the green LED 45 is turned off and the orange LED 46 is turned on (step S39 in FIG. 9B), and further power supply to the second solenoid 23 is stopped (step S40 in FIG. 9B), automatically placing the switching lever 24 to the locking position.

In contrast, when the first switch 41 detects that the door 12 is opened (step S37: YES in FIG. 9A), the first switch 41 then detects whether or not the door 12 is closed by the user (i.e., whether or not the hook 26 is rotated from the opened position to the closed position) (step S38 in FIG. 9A).

When the first switch 41 does not detect that the door 12 is closed (step S38: NO in FIG. 9A), the program waits until 60 seconds elapse from detection by the second switch 42 (step S37 in FIG. 9A) so that the user removes the baggage from the storage unit (step S381: NO in FIG. 9A).

If the door 12 is not closed even after a lapse of 60 seconds (step S381: YES in FIG. 9A), the green LED 45 and the orange LED 46 are blinked (step S382 in FIG. 9A) and the display unit 32 of the operating unit 30 displays an error to prompt the user to close the door 12 (step S383 in FIG. 9A). In the present embodiment, the flow returns to step S38 after displaying the error on the display unit 32 of the operating unit 30 and further waits for; however, measures can be taken to make the storage unit 10 unavailable.

When the first switch 41 detects that the door 12 is closed (step S38: YES in FIG. 9A), the green LED 45 is turned off and the orange LED 46 is turned on (step S39 in FIG. 9B). Then, power supply to the second solenoid 23 is stopped (step S40 in FIG. 9B), automatically placing the switching lever 24 to the locking position.

Whether or not the switching lever 24 is placed in the locking position is detected by the second switch 42 (step S41 in FIG. 9B).

When the second switch 42 does not detect that the switching lever 24 is placed in the unlocking position (step S41: NO in FIG. 9B), indicating that the locking device 20 may have a malfunction, the green LED 45 and the orange LED 46 are blinked (step S411 in FIG. 9B), and an error is displayed on the display unit 32 of the operating unit 30 and the error is notified to a management device via the communication unit 52 (step S412 in FIG. 9B). The error can be cleared by the management device.

After the second switch 42 detects that the switching lever 24 is located in the unlocking position (step S41: YES in FIG. 9B), the program waits for 30 seconds (step S42 in FIG. 9B). This standby time is the time during which a user is allowed to manually turn the switching lever 24 to the unlocking position to switching the door 12 to the unlocked state, for example, if the user has forgotten to remove the baggage from the storage unit 10.

During a standby time of 30 seconds (step S42: NO in FIG. 9B), when the second switch 42 detects that the switching lever 24 is located in the unlocking position, that is, when the user manually turns the switching lever 24 to the unlocking position (step S43: YES in FIG. 9B), the flow returns to step S37.

After a lapse of the standby time of 30 seconds (step S42: YES in FIG. 9B), power supply to the first solenoid 22 is stopped (step S44 in FIG. 9B), moving the lever lock plate 25 to the restriction position. Thus, the switching lever 24 is not allowed to be manually placed to the unlocking position.

Whether or not the lever lock plate 25 is located in the restriction position is detected by the third switch 43 (step S45 in FIG. 9B).

When the third switch 43 does not detect that the lever lock plate 25 is located in the restriction position (step S45: NO in FIG. 9B), indicating that the locking device 20 may have a malfunction, the green LED 45 and the orange LED 46 are blinked (step 451 in FIG. 9B), and an error is displayed on the display unit 32 of the operating unit 30 and the error is notified to a management device via the communication unit 52 (step S452 in FIG. 9B). The error can be cleared by the management device.

When the third switch 43 detects that the lever lock plate 25 is located in the restriction position (step S45: YES in FIG. 9B), the program waits for a standby time of 60 seconds (step S46 in FIG. 9B). This period of 60 seconds is the standby time for receiving the re-unlocking operation to switch the door 12 from the locked state to the unlocked state again, for example, if the user has forgotten to remove the baggage from the storage unit 10. This re-unlocking operation can be received on the operating unit 30.

During the standby time of 60 seconds (step S46: NO in FIG. 9B), when the operating unit 30 receives the re-unlocking operation (step S461: YES in FIG. 9B), the flow returns to step S31, and the same processing (step S31 to S45) is performed as in the flow for retrieving baggage. To prevent unauthorized third parties from re-unlocking the door 12 without permission, it is desirable to authenticate the user when the operation is accepted on the operating unit 30. Specifically, for example, the IC card that was used for payment could be used for authentication of the user.

When the re-unlocking operation is not performed (step S461: NO in FIG. 9B) and 60 seconds elapse (step S46: YES in FIG. 9B), the green LED 45 is turned on and the orange LED 46 is turned off (step S47 in FIG. 9B). Then, the storage unit 10 is switched to the standby mode in which the storage unit 10 is on standby with no baggage stored therein (step S48 in FIG. 9B), and the retrieval program terminates.

### Unlocking Malfunction

Concrete examples of unlocking malfunctions, that is, the case in step S36 in FIG. 9A where the second switch 42 does not detect that the switching lever 24 is placed in the unlocking position (step S36: NO in FIG. 9A) will be described below.

The situation that the switching lever 24 is not moved to the unlocking position even when the second solenoid 23 is energized (step S35) may occur, for example, if a user puts too many items into the storage unit 10. The mechanism thereof is as follows.

When too many items are crammed into the storage unit 10, these items push against the door 12 in the opening direction (e.g., rightward in FIG. 5). When the door 12 is pushed in the opening direction, the door-side hook 121 applies a load to the hook 26, attempting the hook 26 to rotate counterclockwise. When the hook 26 is applied with such the load, the lock pin 263 of the hook 26 presses on the locking lever 27 at the position shown in FIG. 5.

Accordingly, even when the second solenoid 23 is energized, attempting to pull the coupling bar 44 toward the second solenoid 23 (downward in FIG. 5) and cause the pressing part 441 to rotate the locking lever 27, the force of the lock pin 263 that presses on the locking lever 27 is stronger than the force of rotating the locking lever 27, and thus the locking lever 27 could not be rotated. Specifically, the locking lever 27 cannot be moved away from the path of the lock pin 263. This means that the locking device 20 cannot be unlocked, and the door 12 cannot be opened.

However, the locking device 20 can be unlocked manually using the switching lever 24. Specifically, in the S32 in FIG. 9A, the lever lock plate 25 is located in the release position (the position shown in FIG. 5), so that the switching lever 24 can be manually turned from the locking position to the unlocking position. By this manual turning of the switching lever 24 to the unlocking position, the second solenoid 23 is forcibly driven. Specifically, when the switching lever 24 is turned to the unlocking position, the coupling bar 44 is forcibly pushed down toward the second solenoid 23 (downward in FIG. 5), and the pressing part 441 of the coupling bar 44 causes the locking lever 27 to move out of the path of the lock pin 263 (the locking device 20 comes to the state shown in FIG. 6). Thus, the locking device 20 is placed in the unlocked state, allowing the door 12 to be opened.

The locking device 20 separately includes drive means (i.e., the first solenoid 22) for releasing the restriction of the switching lever 24 and drive means (i.e., the second solenoid 23) for operating the switching lever 24 from the locking position to the unlocking position. Therefore, even if too many items are put into the storage unit 10, causing unlocking malfunction, manual unlocking can be easily performed as described above.

In addition, the length L11 (see FIG. 7) from the knob 242 to the rotary shaft 241 is set longer than the length L12 (see FIG. 7) from the connection between the coupling bar 44 and the switching lever 24 to the rotary shaft 241. Therefore, the switching lever 24 can be easily turned manually by the action of leverage.

When the second switch 42 does not detect that the switching lever 24 is placed in the unlocking position (step S36: NO in FIG. 9A), the display unit 32 may provide a guidance prompting a user to manually turn the switching lever 24 to the unlocking position. The timing of displaying the guidance could be, for example, when the second switch 42 does not detect that the switching lever 24 is placed in the unlocking position, within 60 seconds (one example of a predetermined time) from the start of energization of the second solenoid 23 (step S35). However, the above-mentioned 60-second time is merely one example and can be adjusted appropriately within a range that does not make users feel unnatural.

### Emergency Unlocking of Locking Device

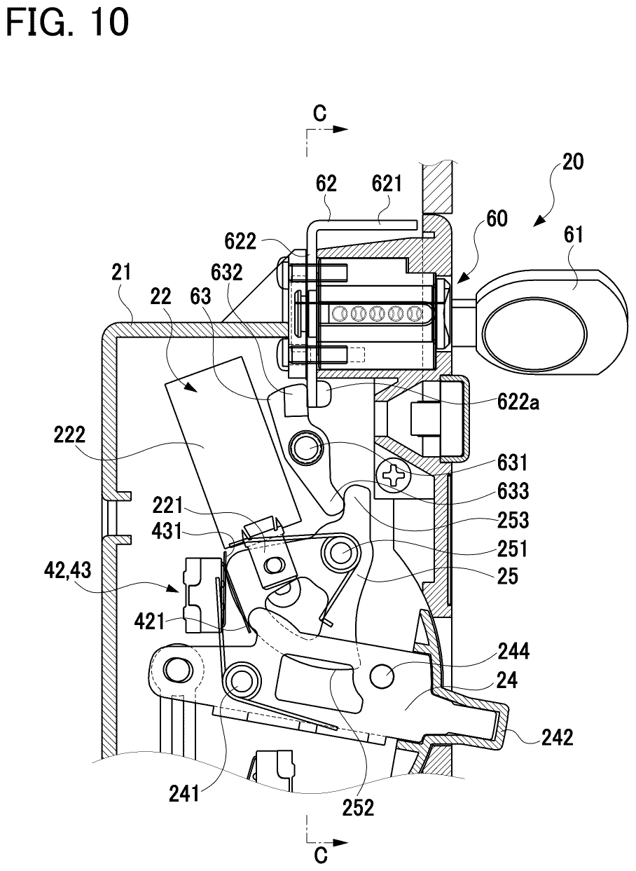

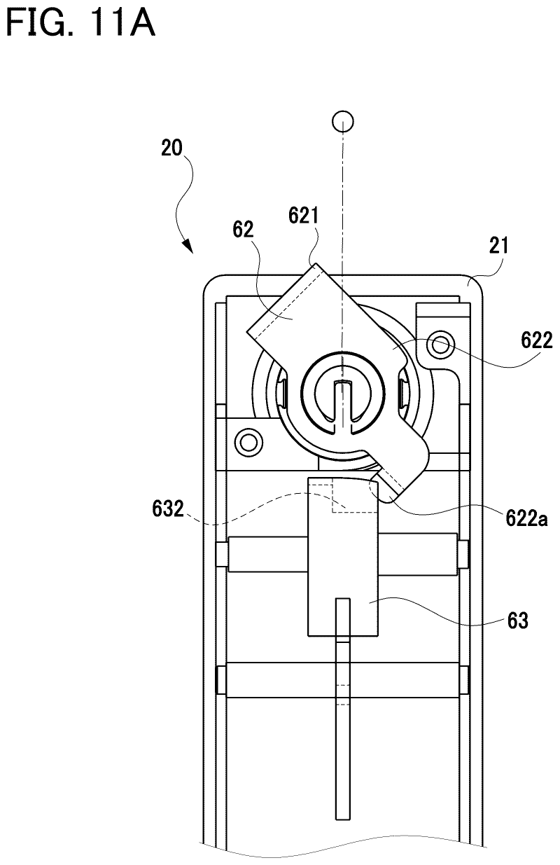

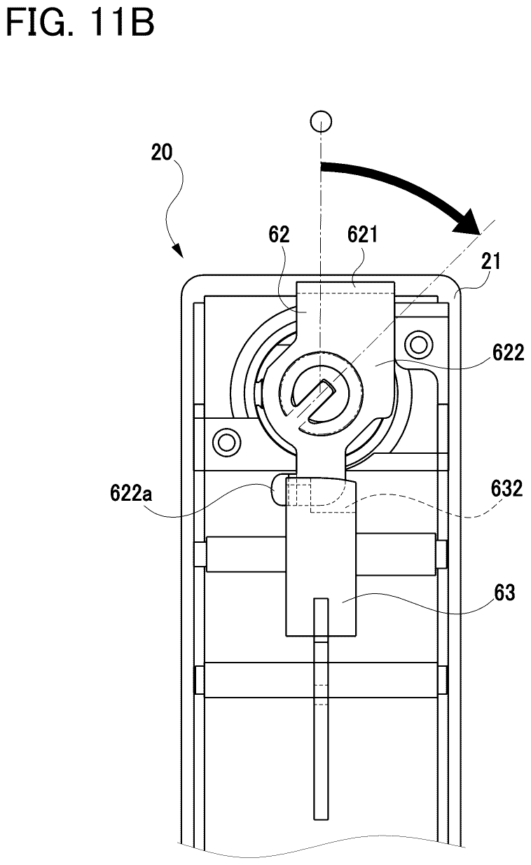

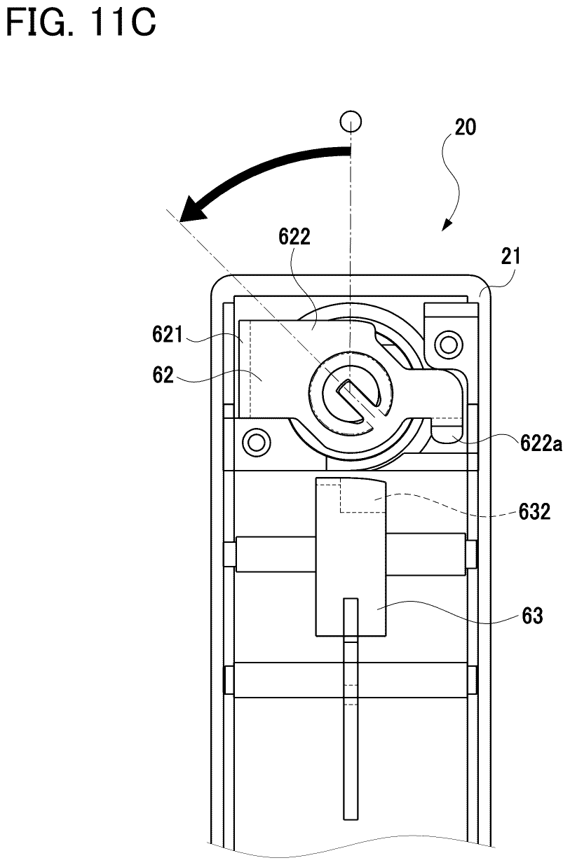

While the storage unit 10 is in the standby mode, the locking device 20 continuously keeps the door 12 in the locked state. However, in emergency situations, the door 12 can be unlocked using an emergency key 61 (see FIG. 10). FIG. 10 is a cross-sectional view of the locking device 20, similar to FIG. 4, showing a state in which emergency unlocking is performed. FIG. 11A is a cross-sectional view taken along a line C-C in FIG. 10, showing a normal usage state of the locking device 20. FIG. 11B is a cross-sectional view taken along the line C-C in FIG. 10, showing a state in which the locking device 20 is subjected to emergency unlocking. FIG. 11C is a cross-sectional view taken along the line C-C in FIG. 10, showing a state in which the locking device 20 can be removed from the casing frame 11.

The locking device 20 includes, as shown in FIG. 4, a cylinder cam 62 in the upper part of the case 21. The cylinder cam 62 can be rotated with the emergency key 61. Furthermore, an emergency unlocking cam 63 is provided adjacent to the first solenoid 22 in the case 21.

The cylinder cam 62 is rotatable between a first position (the position shown in FIG. 11A) which is a normal position, a second position (the position shown in FIG. 11B) for performing emergency unlocking, and a third position (the position shown in FIG. 11C) for removing the locking device 20 from the casing frame 11.

The cylinder cam 62 includes a come-off stopper part 621 for preventing the locking device 20 from coming off the casing frame 11, as shown in FIG. 4. When the cylinder cam 62 is in the first position, the come-off stopper part 621 protrudes above the upper end face of the case 21 (see FIG. 4 or FIG. 11A). Accordingly, even if an attempt is made to remove the locking device 20 from the casing frame 11, the come-off stopper part 621 comes into contact with the back side of the casing frame 11, thereby preventing the locking device 20 from coming off the casing frame 11.

The cylinder cam 62 includes an extension part 622 extending from the come-off stopper part 621 to the inside of the case 21 as shown in FIG. 4. The extension part 622 has a tip serving as a cam part 622a for activating the emergency unlocking cam 63. The cam part 622a is inclined toward the rear right side in FIG. 4 (toward the rear left side in FIGS. 11A-C).

The emergency unlocking cam 63 is rotatable about the central axis 631 within the case 21, between the normal position shown in FIG. 4 and the emergency unlocking position shown in FIG. 10. The emergency unlocking cam 63 includes a contact part 632 provided to be able to contact with the cam part 622a. This contact part 632 is formed of a surface inclined in the same direction as the cam part 622a. Furthermore, the emergency unlocking cam 63 includes a pressing part 633 on the end opposite the contact part 632 relative to the central axis 631. The pressing part 633 can contact with a protruding portion 253 provided on the upper end of the lever lock plate 25.

With the foregoing configuration, emergency unlocking will be performed as below. When the emergency key 61 is inserted in the keyhole 60 and turned 45° counterclockwise (clockwise in FIGS. 11A-C), the cylinder cam 62 is also rotated 45° from the first position to the second position. At that time, the cam part 622a of the cylinder cam 62 comes into contact with the contact part 632 of the emergency unlocking cam 63. Since both the cam part 622a and the contact part 632 are inclined, the emergency unlocking cam 63 is rotated from the normal position toward the emergency unlocking position as the cylinder cam 62 is rotated. When the emergency unlocking cam 63 is rotated to the emergency unlocking position, the pressing part 633 presses the protruding portion 253 of the lever lock plate 25, thereby rotating the lever lock plate 25 from the restriction position to the release position. Once the lever lock plate 25 is placed in the release position, the switching lever 24 can be manually turned to the unlocking position, enabling the door 12 to be opened.

After emergency unlocking is performed, when the emergency key 61 is rotated 90° clockwise (counterclockwise in FIGS. 11A-C), the cylinder cam 62 is also rotated 90° from the second position to the third position. Then, the come-off stopper part 621 of the cylinder cam 62 is located below the upper end face of the case 21 as shown in FIG. 11C, allowing the locking device 20 to be removed from the casing frame 11. This removal of the locking device 20 from the casing frame 11 must be performed only after emergency unlocking is performed. This is because, unless emergency unlocking is done, the hook 26 remains engaged with the door-side hook 121 of the door 12 and thus the locking device 20 cannot be removed.

### Door Opening/Closing Direction

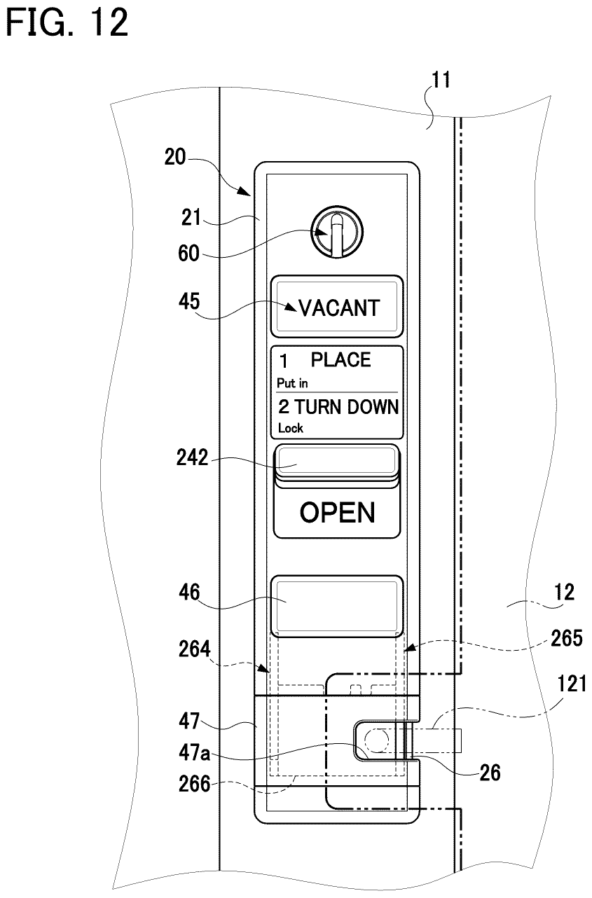

The locking device 20 can be used for either a left-hand door 12 or a right-hand door 12 according to the orientation of a handing change piece 47 attached to the front of the case 21. FIG. 12 is a front view of the locking device 20 corresponding to the right-hand door 12.

The handing change piece 47 is a nearly rectangular component with its longitudinal direction parallel to the horizontal direction when viewed from the front of the case 21, as shown in FIG. 3 or FIG. 12. The handing change piece 47 has an opening 47a at one of ends in the longitudinal direction to allow the door 12 to enter the case 21. As shown in FIG. 3, when the handing change piece 47 is attached to the case 21 so that the opening 47a is positioned on the left side in a front view, the handing change piece 47 is adaptable to the left-hand door 12 (e.g., the door 12 of the storage unit 10 located on the left side of the operating unit 30 in FIG. 1). On the other hand, as shown in FIG. 12, when the handing change piece 47 is attached to the case 21 so that the opening 47a is positioned on the right side in the front view, the handing change piece 47 is adaptable to the right-hand door 12 (e.g., the door 12 of the storage unit 10 located on the right side of the operating unit 30 in FIG. 1).

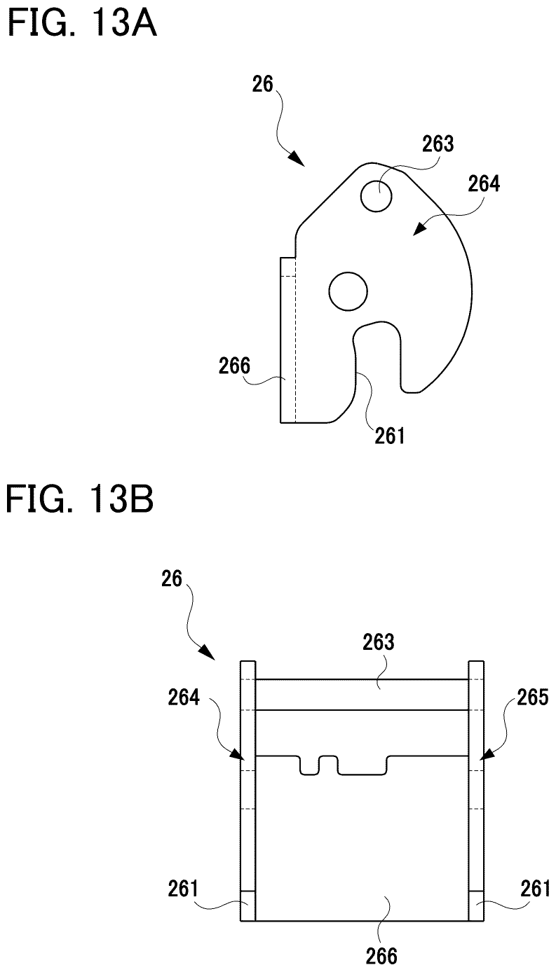

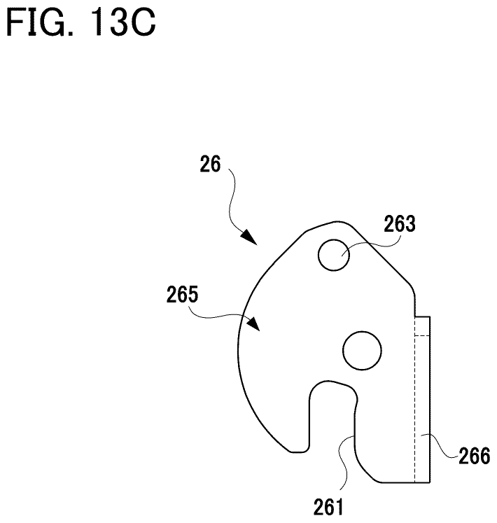

The handing change piece 47 can be used for either the left-hand door 12 or the right-hand door 12 depending on the orientation as above because the hook 26 has the following shape. The details thereof will be described below referring to FIGS. 13A-C. FIG. 13A is a left side view of the hook 26. FIG. 13B is a front view of the hook 26. FIG. 13C is a right side view of the hook 26.

The hook 26 includes a first hook part 264 located on the left side in the front view, a second hook part 265 located on the right side in the front view, and a connecting part 266 laterally connecting the first hook part 264 and the second hook part 265, as shown in FIGS. 13A-C. The connecting part 266 laterally extends between the rear ends of the first hook part 264 and the second hook part 265 in the front view, so that the hook 26 has a nearly reversed U-shape in a plan view. The first hook part 264 and the second hook part 265 each have an engagement part 261.

The hook 26 configured as above is installed in the case 21 so that the first hook part 264 is positioned on the left side of the case 21 in the front view and the second hook part 265 is positioned on the right side of the case 21 as shown in FIG. 3 and FIG. 12. In addition, as shown in FIG. 3, when the handing change piece 47 is attached to the case 21 so that the opening 47a is positioned on the left side in the front view, the hook door-side 121 of the left-hand door 12 enters the case 21 through the opening 47a, and engages with the engagement part 261 of the first hook part 264. On the other hand, as shown in FIG. 12, when the handing change piece 47 is attached to the case 21 so that the opening 47a is positioned on the right side in the front view, the door-side hook 121 of the right-hand door 12 enters the case 21 through the opening 47a, and engages with the engagement part 261 of the second hook part 265.

As described above, the locking device 20 according to the present embodiment is characterized in (1) the locking device capable of performing: the first switching operation of switching from the locked state in which the door 12 of the storage unit 10 capable of storing an item is locked to the unlocked state in which the door 12 is unlocked; and the second switching operation of switching from the unlocked state to the locked state. The locking device 20 includes: the first restricting means (e.g., the lever lock plate 25) that implements the restriction (first restriction) of the first switching operation in the locked state; the first drive means (e.g., the first solenoid 22) that drives the first restricting means to implement or release the first restriction;
the locking member (the hook 26) movable between the closed position for holding of the door 12 in the closed state and the open position for releasing the holding;
the second restricting means (e.g., the locking lever 27) that implements the restriction (second restriction) of movement of the locking member (the hook 26) from the closed position to the open position in the locked state;
the second drive means (e.g., the second solenoid 23) that drives the second restricting means (e.g., the locking lever 27) to implement or release the second restriction; and the manual lever (e.g., the switching lever 24) capable of forcibly performing the first switching operation and driving the second restricting means.
(2) The locking device 20 described in (1) preferably includes the detection means (e.g., the second switch 42) that detects that the second restriction is released; and the controller 51 that controls the locking device 20. The controller 51 stores the control program (e.g., the retrieval program 512b) configured to:
activate the first drive means (the first solenoid 22) to release the first restriction (steps S32-S33);
then, activate the second drive means (the second solenoid 23) to issue a command to release the second restriction (step S35); and
provide a notification prompting to forcibly perform the first switching operation using the manual lever (the switching lever 24) when the detection means (the second switch 42) does not detect that the second restriction is released even after a predetermined time (e.g., 60 seconds) elapses after the first restriction is released (step S36: No).

Further, as described above, the storage apparatus (e.g., the locker apparatus 1) according to the present embodiment includes the locking device 20 described in (1) or (2).

According to the locking device 20 or the storage apparatus (the locker apparatus 1) described above, it is possible to easily unlock even if too many items are put in a storage unit.

The foregoing embodiments are merely examples and give no limitation to the present invention. The present invention may be embodied in other specific forms without departing from the essential characteristics thereof.

For instance, users who place items into the locker apparatus 1 and users who retrieve the items from the locker apparatus 1 are not always the same persons. Specifically, in recent years, railway stations are widely regarded as physical distribution hubs, and it is conceivable that transport companies that deliver goods ordered by general consumers will become users who drop off articles or goods, and the general consumers who ordered the goods will become users who pick up the articles or goods. In this case, for example, a specific transport company is permitted in advance to use the locker apparatus 1, and the storage program is executed after the transport company is authenticated via the operating unit 30. The authentication for pickup of the articles or goods is performed, for example, in a manner that an authentication code such as a QR code (registered trademark) is transmitted in advance to a mobile device or the like of the general consumer, and the retrieval program is executed after the authentication code is authenticated.

Furthermore, for example, the locker apparatus installed in a station is shown as one example of the storage apparatus; however, the storage apparatus is not limited thereto and may be a delivery locker installed in an apartment building, etc.

### REFERENCE SIGNS LIST

1 Locker apparatus (one example of Storage apparatus)
10 Storage unit
12 Door
20 Locking device
22 First solenoid (one example of First drive means)
23 Second solenoid (one example of Second drive means)
24 Switching lever (one example of Manual lever)
25 Lever lock plate (One example of First restricting means)
26 Hook (One example of Locking member)
27 Locking lever (One example of Second restricting means)

1. A locking device capable of performing:
a first switching operation of switching from a locked state in which a door of a storage unit capable of storing an item is locked to an unlocked state in which the door is unlocked; and
a second switching operation of switching from the unlocked state to the locked state,
wherein the locking device comprises:
first restricting means that implements first restriction, which is restriction of the first switching operation, in the locked state;
first drive means that drives the first restricting means to implement or release the first restriction;
a locking member movable between a closed position for holding of the door in a closed state and an open position for releasing the holding;
second restricting means that implements second restriction, which is restriction of movement of the locking member from the closed position to the open position, in the locked state;
second drive means that drives the second restricting means to implement or release the second restriction; and
a manual lever capable of forcibly performing the first switching operation and driving the second restricting means.

2. The locking device according to claim 1, comprising:
detection means that detects that the second restriction is released; and
a controller that controls the locking device,
wherein the controller stores a control program configured to:
activate the first drive means to release the first restriction;
then, activate the second drive means to issue a command to release the second restriction; and
provide a notification prompting to forcibly perform the first switching operation using the manual lever when the detection means does not detect that the second restriction is released even after a predetermined time elapses after the first restriction is released.

3. A storage apparatus provided with the locking device according to claim 1.

4. A storage apparatus provided with the locking device according to claim 2.
